(19) United States
(12) Patent Application Publication
(10) Pub. No.: US 2006/0196043 A1
(43) Pub. Date: Sep. 7, 2006

(54) Boiler wall tube welding tool

(76) Inventor: Scott Holloway, Chehalis, WA (US)

Correspondence Address: BRIAN J. COYNE;MILES WAY COYNE, PLLC, 2401 Bristol Court S.W., Olympia, WA, 98502, US

(21) Appl. No.: 11/074,950

(22) Filed: Mar. 7, 2005

(51) Int. Cl. B23P 15/26

(52) U.S. Cl. 29/726

(57) ABSTRACT

A boiler wall tube tool for clamping together for welding adjacent ends of boiler wall tube segments in a boiler wall having narrowly spaced apart tubes. The tool includes a base with a tube engaging recess, and a pair of clamp members that attach to the base. The base has cutouts and notches to facilitate a welder's observation of the welding process. Each of the pipe clamp members includes a parallel pair of guides that are insertable between adjacent tubes of a boiler wall and are attachable by nuts and bolts to opposite sides of the base. A header that joins the guides has a threaded bore. A saddle block mounted for sliding movement between the guides is attached by a swivel nut to a clamp screw that is mounted within the threaded bore. Each saddle block is recessed for engaging an exterior surface of one of two aligned tube segments. The tool clamps aligned segments together by rotation of the clamp screws in a first direction; rotation of the screws in an opposite direction permits detaching the tool from the pipe segments. A lateral adjustment screw is provided for adjusting the tool for snug fit to adjacent, aligned tube segments.

### CROSS REFERENCE TO RELATED Applications

None.

### STATEMENT REGARDING GOVERNMENT SPONSORED RESEARCH

None

### BACKGROUND OF THE INVENTION

1. Field of the Invention

This invention relates to a tool for clamping the ends of boiler wall tubes in alignment so that the ends of the tubes may be welded together. More particularly, the present invention relates to a boiler wall tube welding tool designed for use in boiler tube walls having closely spaced, laterally adjacent tubes joined by a web.

2. Background Art

Boiler walls comprise a parallel array of tubes through which water circulates. Over time, the tubes degrade and must be replaced. Replacement proceeds by cutting out a portion of the wall that contains the tube segments that need replacing, followed by aligning, clamping, and welding new tube segments to the severed ends of the tubes. The remainder of the cut out portion of the wall is then restored. Various tools for clamping the ends of tubes in alignment preparatory to welding have been disclosed; see, for example, U.S. Pat. No. 2,108,077 to Robinson and U.S. Pat. No. 817,513 to Parker. Some boiler walls are constructed such that the spacing between adjacent tubes is very small. A hook and bolt type boiler wall tube tool was disclosed by McClure in U.S. Pat. No. 5,481,793 for use in boiler walls having narrow tube spacings. But, prior to my invention, there still remained an unresolved problem in welding narrowly spaced boiler wall tube segments: the narrow spacing between adjacent tubes prevented a welder who was performing a weld from observing the welding operation as it proceeded around the periphery of the aligned tube segments and away from the welder; particular, the welder could not see whether the sides of the tubes to be welded were in alignment. Therefore, a tool is needed for boiler walls having closely spaced tubes that clamps the tubes to be welded in alignment and affords good visual access to the site of the weld.

### SUMMARY OF THE INVENTION

The kind of boiler wall that is of concern here comprises a parallel array of boiler wall tubes wherein adjacent surfaces of adjacent tubes are joined by webs; moreover, the spacings between adjacent tubes are narrow. Consequently, there is very limited space for a welder to view a weld site so that it is important that any welding tool that is used to clamp into alignment tubes that are to be joined by welding not excessively occlude the available viewing area. The present invention provides a boiler wall tube welding tool that includes a base and a pair of clamp members that attach to the base. The base has a first section and a second section joined by a mid-section. Each of the first and second sections and the mid-section of the base are longitudinally aligned. A pipe engaging surface of the base has a longitudinal recess suitable for engaging a first, exterior surface of adjacent, aligned ends of boiler wall tube segments. The mid-section of the base has a laterally spaced apart, oppositely-directed pair of cutouts to facilitate visual observation of adjacent ends of boiler wall tube segments while they are being welded.

Each of the pipe clamp members is adapted for engaging a second, opposite exterior surface of the boiler wall tube segments. Each pipe clamp member includes a parallel pair of laterally spaced-apart guides. Each of the guides has a first end and an opposite second end. The second ends of the guides are adapted for insertion into the narrow spaces between adjacent boiler wall tube segments and for attachment to opposite sides of the base. A laterally-directed header that joins the first ends of the guides. The header has a centrally disposed, threaded bore. A clamp screw is threaded into the threaded bore of the header. The clamp screw has a drive nut at a first end thereof and a swivel nut at an opposite, second end thereof. A saddle block is attached to the swivel nut and is disposed for sliding movement between the guides in response to rotation of the screw. Each saddle block of each pipe clamp member has a longitudinal recess adapted for engaging a second, opposite surface of said boiler wall tube segments. Means is provided for reversibly attaching the pipe clamp members to the base in longitudinally spaced-apart relation such that the base, in cooperation with the pair of pipe clamp members, surrounds the new pipe segments that are to be welded into the boiler wall and clamps them in alignment with the severed ends of the pipe segments to which the new pipe segments are to be welded; said means preferably includes bolts laterally inserted through apertures in the second ends of the guides of each pipe clamp member and though lateral bores in the base, said bolts being secured by nuts. Each saddle block has opposite, laterally spaced-apart sides, which sides are preferably recessed to receive and engage the guides. The tool preferably further includes a lateral adjustment bolt threaded into a threaded bore that is normal to, and extends through, a central portion of the longitudinal recess of the base. The adjustment bolt permits adjusting the tool to snugly engage irregular surfaces of boiler tube segments.

Accordingly, it is an object of the invention to provide a boiler wall tube welding tool that maintains in alignment during welding the ends of closely spaced laterally adjacent tubes within a boiler tube wall, and provides adequate visual access to the site of the weld.

Another object of the invention is to provide such a tool with a pair of clamp members, each clamp member having a saddle block attached by a swivel nut to a clamp screw, whereby uneven and out of round pipe segments can be snugly clamped by the tool.

A further object of the invention is to provide such a tool with an adjustment bolt that permits adjusting the tool to snugly engage irregular surfaces of boiler tube segments.

### BRIEF DESCRIPTION OF THE DRAWINGS

FIG. 1 is a perspective view of a first boiler wall tube tool (A) installed around an upper portion of a tube of a boiler wall and a second, oppositely-directed, boiler wall tube tool (B) installed around a lower portion thereof, in accordance with the present invention.

FIG. 2 is a vertical, cross-sectional view taken through line 2-2 of FIG. 1.

FIG. 3 is a cross-sectional view taken through line 3-3 of FIG. 1.

FIG. 4 is an enlarged view of the tool in a disassembled form.

FIG. 5 is a further enlarged, perspective view of the base of the tool.

FIG. 6 is an enlarged, perspective view of a saddle block removed from the tool.

Except where otherwise noted, similar elements are denoted by the same numeral throughout the several views.

### PREFERRED EMBODIMENT OF THE INVENTION

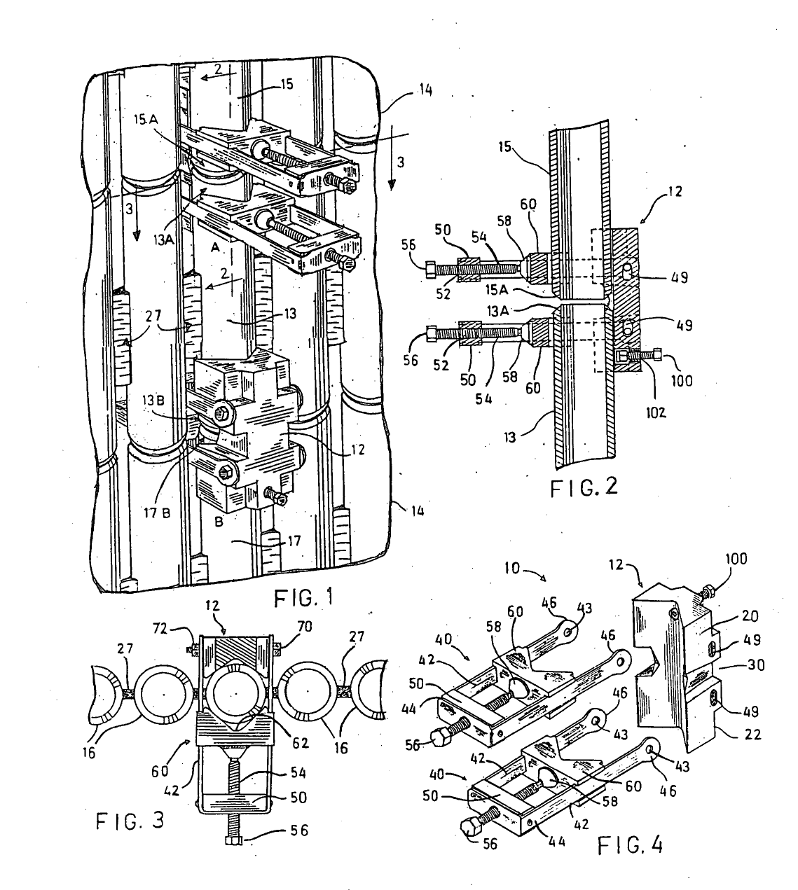

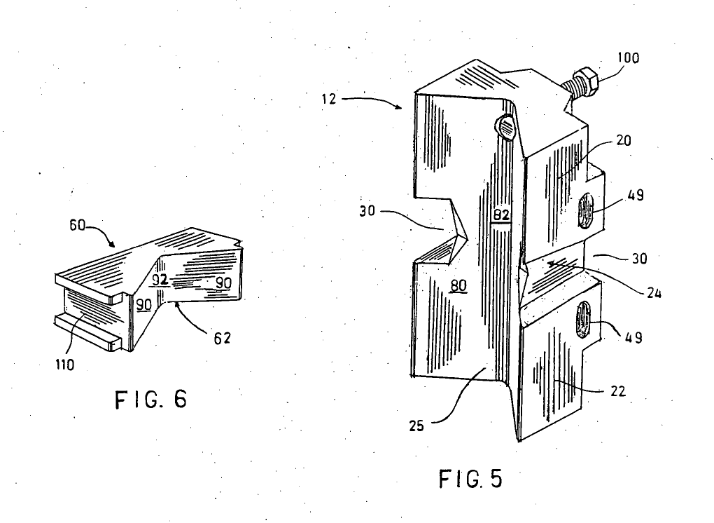

Without limiting the scope of the invention, the preferred features of this invention will be described. In FIGS. 1-3, a boiler wall 14 is depicted in fragmentary, perspective view and comprises a plurality of laterally spaced tubes 16 that are closely spaced together and connected by webs 27. We will suppose that a deteriorated segment of one of the tubes 16 has been severed and removed, leaving in place an upper tube segment 15 and a lower tube segment 17, and a welder is proceeding to replace the missing tube segment with a new tube segment 13. Two of the boiler wall tube tools 10 are depicted in FIG. 1, an upper tool 10 denoted by A and a lower tool 10 denoted by B. The upper tool A is being used to clampingly secure in alignment the ends 13A and 15A of tube segments 13 and 15, respectively; similarly, the lower tool 10 denoted by B is used to clampingly secure in alignment the ends 13B and 17B of pipe segments 13 and 17, respectively. Once welded, the tube segments 13, 15 and 17 will form a single tube 16.

The tool 10 includes a base 12 that includes a first section 20 and second section 22 joined in longitudinal alignment by a mid-section 24, as may best be seen in FIG. 5. The base 12 has a longitudinal recess 25 suitable for engaging a first, exterior surface of adjacent aligned ends of boiler wall tube segments—for example, aligned tube segments 13 and 15, and aligned tube segments 15 and 17. The recess 25 comprises a first pair of sloped surfaces 80 joined by a straight surface 82. The mid-section 24 of the base 12 has a laterally spaced-apart, oppositely-directed pair of cutouts 30 to facilitate visual observation of adjacent ends of boiler wall tube segments while being welded. To further enhance visibility, the mid-section 24 of the base 12 is notched adjacent each of the cutouts 30.

The tool 12 further comprises a pair of pipe clamp members 40 for engaging a second, opposite exterior surface of the boiler wall tube segments. That is, the base 12 from one side and the pipe clamp members 40 from an opposite side, surround aligned pipe segments to clamp them together long enough for the welder to weld them. Each pipe clamp member 40 includes a parallel pair of laterally spaced-apart guides 42. Each guide 42 has a first end 44 and an opposite, second end 46. The second ends 46 are adapted for insertion between adjacent boiler wall tube segments and for attachment to opposite sides of the base 12. Referring to FIG. 4, it may be seen that the second ends 46 of each guide 42 have apertures 43. Means are provided for reversibly attaching the second ends 46 to opposite sides of the base 12; said means are preferably a bolt 70 inserted through the apertures 43 in the guides 42 and through lateral bores 49 in the first and second sections 20, 22 of the base 12, each bolt 70 secured by a nut 72. As may best be seen in FIG. 5, the lateral bores 49 preferably have an oblong cross section to facilitate slight longitudinal adjustment of the guides 42 with respect to the base 12. A laterally-directed header 50 joins the first ends 44 of the guides 42; the header 50 has a centrally disposed, threaded bore 52. A clamp screw 54 is provided in threaded engagement with the threaded bore 52 of the header 50. The clamp screw 54 has a drive nut 56 at a first end thereof and a swivel nut 58 at an opposite, second end thereof. Each pipe clamp member 40 further includes a saddle block 60 attached to the swivel nut 58. The saddle block 60 is disposed for sliding movement between the guides 42 in response to rotation of the screw 54. To that end, each saddle block 60 has opposite, laterally spaced-apart sides 110, and the sides 110 are recessed to receive and engage the guides 42. Each saddle block 60 has a longitudinal recess 62 adapted for engaging a second, opposite surface of the boiler wall tube segments—that is, opposite to the tube segment surface engaged by the longitudinal recess 25 in the base 12.

In use, after removing a deteriorated segment of tube from a boiler wall tube and after removing sufficient amount of the web 27 to have adequate working room, a welder cuts to the required length a replacement tube segment 13, mills the cut edges to form oppositely-directed, 30 degree chamfered edges, attaches the first and second section of the base 12 with bolts 70 and nuts 72 to clamp members 40 of a first tool B, and slides the tool B over the tube segment end 17B. The drive nuts 56 are tightened, therby aligning the tube segments 13, 15 and 17. A lateral adjustment bolt 100 threaded into a threaded bore 102 that is normal to, and extends through, a central portion of the longitudinal recess 25 of the base 12, is adjusted to achieve a snug fit for each the tools A and B. The welder tack welds the sides of the tubes, which is sufficient to temporarily hold the aligned tubes together. For Tungsten Inert Gas (TIG) welding, a helper stationed on the opposite side of the wall feeds welding wire through the space between adjacent tubes toward the welder while the welder proceeds to weld the sides of tube segment 13A to tube segment 15A and tube segment 13B to tube segment 17B. Thereafter, the welder feeds welding wire to the helper who similarly welds the face and sides of the tubes that are accessible to him from his side of the wall.

Various changes and modifications will become obvious to those skilled in the art. It is the intent that these changes and modifications are to be encompassed within the spirit of the appended claims and that the invention described herein an shown in the accompanying drawings is illustrative only and not intended to limit the scope of the invention.

I claim:

1. A boiler wall tube welding tool for clamping together adjacent ends of boiler wall tube segments in a boiler wall, the tool comprising:
a base that includes a first section and a second section joined by a mid-section, each of said first and second sections and said mid-section being aligned longitudinally, said base having a longitudinal recess suitable for engaging a first, exterior surface of adjacent, aligned ends of boiler wall tube segments, and said mid-section having a laterally spaced apart, oppositely-directed pair of cutouts to facilitate visual observation of adjacent ends of boiler wall tube segments while being welded;
a pair of pipe clamp members adapted for engaging a second, opposite exterior surface of said boiler wall tube segments, each pipe clamp member including
a parallel pair of laterally spaced-apart guides, each of said guides having a first end and an opposite second end, said second ends being adapted for insertion between adjacent boiler wall tube segments and for attachment to opposite sides of the base;
a laterally-directed header that joins the first ends of the guides, said header having a centrally disposed, threaded bore;
a clamp screw in threaded engagement with the threaded bore of the header, said screw having a drive nut at a first end thereof and a swivel nut at an opposite, second end thereof; and
a saddle block attached to the swivel nut and disposed for sliding movement between the guides in response to rotation of the screw, said saddle block having a longitudinal recess adapted for engaging a second, opposite surface of said boiler wall tube segments; and
means for reversibly attaching the pipe clamp members to the base in longitudinally spaced-apart relation.

2. The tool of claim 1, wherein the second ends of the guides are apertured, and the means for reversibly attaching the pipe clamp members to the base in longitudinally spaced-apart relation are bolts inserted through the apertures in the guides and through lateral bores in the first and second sections of the base and secured by nuts.

3. The tool of claims 1 or 2, wherein the recess of the base comprises a first pair of sloped surfaces joined by a first straight surface and the recess of each of the saddle blocks comprises second and third pairs of sloped surfaces joined, respectively by second and third straight surfaces suitable for partially surrounding and engaging an exterior surface of a tube segment.

4. The tool of claim 3, wherein the recess of the mid-section of the base is notched adjacent each of said cutouts to further facilitate visual observation of welding operations.

5. The tool of claim 3, wherein each saddle block has opposite, laterally spaced-apart sides, and said sides are recessed to receive and engage the guides.

6. The tool of claim 3, further comprising a lateral adjustment bolt threaded into a threaded bore that is normal to, and extends through, a central portion of the longitudinal recess of the base.
